(19) United States
(12) Patent Application Publication
(10) Pub. No.: US 2024/0091984 A1
(43) Pub. Date: Mar. 21, 2024

(54) MOLD INSERT MEMBER, METHOD, AND MOLD FOR MITIGATING MALFORMATION OF INTERLOCKING RETAINING WALL BLOCKS, AND RETAINING WALL BLOCKS PRODUCED THEREBY

(71) Applicant: Risi Stone Inc., Newmarket (CA)

(72) Inventor: Tyler Matys, Newmarket (CA)

(73) Assignee: Risi Stone Inc., Newmarket (CA)

(21) Appl. No.: 18/242,365

(22) Filed: Sep. 5, 2023

Related U.S. Application Data
(60) Provisional application No. 63/407,506, filed on Sep. 16, 2022.

(30) Foreign Application Priority Data
Oct. 4, 2022 (CA) 3178337
Jan. 6, 2023 (CA) 3186121

(51) Int. Cl. B28B 7/00

(52) U.S. Cl. CPC B28B 7/0002; B28B 7/0097

(57) ABSTRACT

Provided herein are various embodiments of molds, mold insert members, and methods, for mitigating malformation of interlocking retaining wall blocks, and retaining wall blocks produced thereby. In an embodiment, an insert member for a retaining wall block mold includes a convexly-arched front wall portion and a convexly-arched rear wall portion, for forming respective concavely-arched top side and bottom side portions of respective concrete retaining wall blocks. The concavely-arched portions resist malformation such as bulge and/or slump that may tend to occur between molding and curing of the concrete retaining wall blocks due to pressure within the block. The concavely-arched portions additionally provide respective concavities into which such malformations—should they occur despite being resisted by the concavely-arched portions—may be channeled, thereby to keep malformations within the intended envelope of the retaining wall block.

### CROSS-REFERENCE TO RELATED APPLICATIONS

This application claims priority to U.S. Provisional Patent Application Ser. No. 63/407,506 entitled “METHOD AND MOLD FOR CONTROLLING FOR SLUMP AND BULGE DURING MANUFACTURE OF INTERLOCKING CONCRETE RETAINING WALL BLOCKS” filed on Sep. 16, 2022, to Canadian Patent Application No. 3178337 entitled “METHOD AND MOLD FOR CONTROLLING FOR SLUMP AND BULGE DURING MANUFACTURE OF INTERLOCKING CONCRETE RETAINING WALL BLOCKS” filed on Oct. 4, 2022, and to Canadian Patent Application No. 3186121 entitled “MOLD INSERT MEMBER, METHOD, AND MOLD FOR MITIGATING MALFORMATION OF INTERLOCKING RETAINING WALL BLOCKS, AND RETAINING WALL BLOCKS PRODUCED THEREBY” filed on Jan. 6, 2023, the contents of which are incorporated herein by reference.

### FIELD OF THE INVENTION

The present disclosure relates generally to prefabricated concrete retaining wall blocks, and more particularly to mold insert members, methods, and molds for mitigating malformation of interlocking concrete retaining wall blocks, and interlocking retaining wall blocks produced using same.

### BACKGROUND OF THE INVENTION

Interlocking concrete blocks are used for many outdoor construction applications, one of the most common being the construction of retaining walls. Interlocking concrete blocks are designed for durability, stability, and aesthetic appeal. Such blocks used in retaining wall applications are commonly referred to as Segmental Retaining Wall Blocks, or SRWs.

Often, SRWs are dry-stacked (no mortar) on top of each other and have a connection system to interlock the blocks thereby to together resist forces from that which is being retained, such as soil. Such a connection system may involve the interaction of one or more tongues on one block with one or more corresponding grooves on an adjacent block, or some other type of shear connector or pin connector system.

Improvements in the manufacturing of interlocking SRWs are desirable. For example, it may be useful to mitigate malformation that may tend to occur during manufacture of SRWs and that could affect stacking and/or interlocking of the manufactured SRWs.

### SUMMARY OF THE INVENTION

In accordance with an aspect, there is provided an insert member for a retaining wall block mold, the insert member comprising: an insert body comprising: a top side and a bottom side opposite the top side; a front side and a rear side opposite the front side; and a first side and a second side opposite the first side; the front side having a front wall extending between the first and second sides and having at least, in seriatim from the bottom side to the top side: a vertical first front wall portion; a convexly-arched vertical second front wall portion; and a rearwardly-oblique third front wall portion; the rear side having a rear wall extending between the first and second sides and having at least, in seriatim from the bottom side to the top side: a vertical first rear wall portion; a rearwardly-oblique second rear wall portion, the second rear wall portion parallel to the third front wall portion; and a convexly-arched vertical third rear wall portion.

In an embodiment, a vertical height of the first rear wall portion is greater than a combined vertical height of the first and second front wall portions.

In an embodiment, a vertical height of the first rear wall portion is the same as a combined vertical height of the first and second front wall portions.

In an embodiment, the third rear wall portion is convexly-arched to a maximum extent of from about 2 millimeters (mm) to about 5 mm.

In an embodiment, the third rear wall portion is convexly-arched to a maximum extent of about 2 millimeters (mm).

In an embodiment, the third rear wall portion is convexly-arched to a maximum extent of about 3 millimeters (mm).

In an embodiment, the third rear wall portion is convexly-arched to a maximum extent of about 4 millimeters (mm).

In an embodiment, the second rear wall portion is convexly-arched to a maximum extent of about 5 millimeters (mm).

In an embodiment, the insert member further comprises, between the third front wall portion and the top side: a vertical fourth front wall portion.

In an embodiment, the front wall and the rear wall have the same vertical height.

In an embodiment, at least one of the vertical first front wall portion, the rearwardly-oblique third front wall portion, the vertical first rear wall portion, and the rearwardly-oblique second rear wall portion, is planar.

According to an aspect, there is provided a retaining wall block formed using a mold that includes the insert member.

According to an aspect, there is provided a mold for manufacturing at least one interlocking dry-cast concrete retaining wall block, the at least one block having a top side having a transverse profile comprising at least one interlocking structure projecting from or recessed into the top side, and a bottom side having a transverse profile comprising at least one complementary interlocking structure recessed into or projecting from the bottom side, the mold comprising: a mold box, comprising front side and rear side walls joined to first side and second side walls to define a mold cavity, a top face, and a substantially open bottom face; partitions configured to define a space between adjacent blocks or a space between a block and a front side wall or a rear side wall of the mold box, extending substantially parallel to the front side wall and the rear side wall of the mold box substantially from the top face into the mold cavity, at least a longitudinal portion of at least some of the partitions being configured to form, without interlocking in a vertical direction with, a first transverse portion of the profile of the top side of one block or a first transverse portion of the profile of the bottom side of an adjacent block, or both, wherein the first transverse portions do not include any undercut portion that would impede vertically lifting the mold box including the partitions off of molded blocks; and at least one removable insert comprising insert members which, when positioned in the mold box in vertical correspondence with respective partitions, extend substantially parallel to the front side wall and the rear side wall and are configured to occupy the space between adjacent blocks, or the space between a block and a front side wall or a rear side wall of the mold box, for forming a remaining transverse portion of the profile of the top side of one block or a remaining transverse portion of the profile of the bottom side of an adjacent block, or both; wherein at least one of the partitions and a corresponding insert member for forming both the transverse portion of the profile of the top side of one block and the transverse portion of the profile of the bottom side of an adjacent block together form a combined body, the combined body having: a front wall extending between first and second sides of the combined body and having, in seriatim from the bottom side to the top side of the mold box: a vertical first front wall portion; a convexly-arched vertical second front wall portion; a rearwardly-oblique third front wall portion; and
a vertical fourth front wall portion; and a rear wall opposite the front wall, the rear wall extending between the first and second sides of the combined body and having, in seriatim from the bottom side to the top side of the mold box: a vertical first rear wall portion; a rearwardly-oblique second rear wall portion, the second rear wall portion parallel to the third front wall portion; a convexly-arched vertical third rear wall portion; and a vertical fourth rear wall portion.

According to an aspect, there is provided a retaining wall block formed using the mold.

According to an aspect, there is provided a retaining wall block comprising: a block body comprising: a top side and a bottom side opposite the top side; a front side and a rear side opposite the front side; and a first side and a second side opposite the first side; the bottom side having, in seriatim from the rear side to the front side: a horizontal first bottom side portion; an upwardly-oblique second bottom side portion; an at least partially concavely-arched horizontal third bottom side portion; and a horizontal fourth bottom side portion; and the top side having, in seriatim from the rear side to the front side: a horizontal first top side portion; an at least partially concavely-arched horizontal second top side portion; an upwardly-oblique third top side portion, the third top side portion parallel to the second bottom side portion; and a horizontal fourth top side portion.

In an embodiment, the at least partially concavely-arched horizontal third bottom surface portion is fully concavely-arched.

In an embodiment, the at least partially concavely-arched horizontal third bottom surface portion is a partially-collapsed concavely-arched horizontal third bottom surface portion.

In an embodiment, the partially-collapsed concavely-arched horizontal third bottom surface portion has, along an extent between the first side and the second side of the block body, at least one substantially concavely-arched region and at least one substantially collapsed concavely-arched region.

In an embodiment, the partially-collapsed concavely-arched horizontal third bottom surface portion has, along the entirely of an extent between the first side and the second side of the block body, a partially-collapsed concavely-arched horizontal region.

In accordance with an aspect, there is provided a set of retaining wall blocks comprising: a plurality of the retaining wall block, wherein, in at least one of the plurality, the at least partially concavely-arched horizontal third bottom surface portion is fully concavely-arched; and in at least one of the plurality, the at least partially concavely-arched horizontal third bottom surface portion is an at least partially-collapsed concavely-arched horizontal third bottom surface portion.

Other aspects and advantages are set forth herein.

### BRIEF DESCRIPTION OF THE FIGURES

Embodiments will now be described more fully with reference to the accompany drawings, in which:

FIG. 1 is a first side cutaway view of a retaining wall block mold being used to form retaining wall blocks;

FIG. 2 is a first side view of a retaining wall formed using retaining wall blocks such as those in FIG. 1;

FIG. 3 is a first side view of a retaining wall block of FIG. 2, in isolation;

FIG. 4 is a first side view of a retaining wall block in isolation and showing a rear side of the retaining wall block having a greater vertical height than its front side;

FIG. 5 is a first side view of a retaining wall formed using several of the retaining wall block of FIG. 4;

FIG. 6 is a first side cutaway view of a retaining wall block mold being used to form retaining wall blocks, showing pressures imparted on front faces of the retaining wall blocks by a compacting press head system;

FIG. 7 is a first side cutaway view of the retaining wall block mold of FIG. 6, with the compacting press head system being lifted and inter-block partitions being lifted from between the blocks;

FIG. 8 is a first side view of the retaining wall blocks of FIG. 7, showing the weight pressures of concrete tending, pre-curing, to cause malformation such as slumping towards the rear sides (oriented towards the bottom of the mold) of the retaining wall blocks;

FIG. 9 is a first side partial view of a retaining wall block mold, having partitions and insert members for forming a vertical interlock system in respective retaining wall blocks while leaving a front face of the retaining wall blocks exposed for, for example, contact by a compacting press head system;

FIG. 10 is a magnified first side partial view of the retaining wall block mold of FIG. 9, showing distribution of pressures that may tend, pre-curing once at least insert members have been removed, to cause concrete to be malformed, in particular to bulge and/or slump, at locations along the top and bottom sides of the retaining wall block (to the right and left, respectively, of the mold) and also to be malformed, in particular to bulge and/or slump, towards a rear side of the block (towards the bottom of the mold);

FIG. 11 is a magnified first side partial view of the retaining wall block mold of FIGS. 9 and 10, showing common locations at which bulge malformation may tend to occur;

FIG. 12 is a first side view of a retaining wall formed using retaining wall blocks in which the bulge malformations depicted in FIG. 11 had occurred;

FIG. 13 is a first side view of an insert member of a mold having features for forming corresponding features in a bottom side of an interlocking retaining wall block that may resist malformation such as bulge and slump at the rearward portion of the bottom side of the block while the block cures in a face-up orientation after mold components have been removed;

FIG. 14 is a magnified partial first side view of features formed in the bottom side of the block of FIG. 13 for resisting malformation such as bulge and slump, and showing a distribution of weight pressures with respect to the features;

FIG. 15 is a magnified partial first side view of features formed in the bottom side of the block of FIG. 13 for resisting malformation such as bulge and/or slump, and showing a partial collapse of the features in the event that resistance is overcome, malformation having been mitigated by the margin of error provided by the features;

FIG. 16 is a first side view of a portion of a bottom side of an interlocking retaining wall block showing a location at which a feature that may resist malformation such as bulge and/or slump at the rearward portion of the bottom side of the block may be located;

FIG. 17A is a first side view of insert members of a mold having features for forming corresponding features in both a top side and a bottom side of an interlocking retaining wall block that may resist malformation such as bulge and/or slump at the rearward portion of the block while the block cures in a face-up orientation after mold components have been removed, and respective partitions;

FIG. 17B is a magnified first side view of one of the insert members of FIG. 17A and its respective partition;

FIG. 18A is a rear side perspective view of the insert member of FIG. 17B;

FIG. 18B is a front side perspective view of the insert member of FIG. 17B;

FIG. 19A is a top perspective view of a mold having a mold box and partitions each with features for cooperating with insert members such as that shown in FIG. 17B to form respective blocks;

FIG. 19B is a first side view of a side of the mold box of FIG. 19A;

FIG. 20A is a first side view of a retaining wall block formed using a mold such as the mold of FIG. 19A;

FIG. 20B is a first side view of an alternative retaining wall block formed using a mold such as the mold of FIG. 19A;

FIG. 20C is a first side view of a second alternative retaining wall block formed using a mold such as the mold of FIG. 19A;

FIG. 21A is a first side view of the insert member of FIG. 17B, showing relative configurations of front and rear wall portions for forming corresponding blocks that can be stacked in interlocking configuration to form a battered retaining wall;

FIG. 21B is a first side view of an alternative insert member, similar to that of FIG. 17B, but showing relative configurations of front and rear wall portions for forming corresponding blocks that can be stacked in interlocking configuration to form a vertical, or “non-battered” retaining wall;

FIG. 22A is a first side view of another alternative insert member and corresponding partition; and

FIG. 22B is a first side view of yet another alternative insert member and corresponding partition.

### DETAILED DESCRIPTION OF THE EMBODIMENTS

Provided herein are various embodiments of molds, mold insert members, and methods, for mitigating malformation of interlocking retaining wall blocks, and retaining wall blocks produced thereby. In an embodiment, an insert member for a retaining wall block mold includes a convexly-arched front wall portion and a convexly-arched rear wall portion, for forming respective concavely-arched top side and bottom side portions of respective concrete retaining wall blocks. The concavely-arched portions resist malformation such as bulge and/or slump that may tend to occur between molding and curing of the concrete retaining wall blocks due to pressure within the block. The concavely-arched portions additionally provide respective concavities into which such malformations—should they occur despite being resisted by the concavely-arched portions—may be channeled, thereby to keep malformations within the intended envelope of the retaining wall block.

The following is provided as an explanation of the invention.

In a dry-cast concrete mold, forming concrete blocks in a vertical or “face-up” orientation allows for the application of various textures and colours to the exposed faces of the blocks. When a mold is configured to manufacture blocks in such a “face-up” orientation, the top and bottom sides of the blocks themselves are formed with fixed rigid sidewalls/partitions.

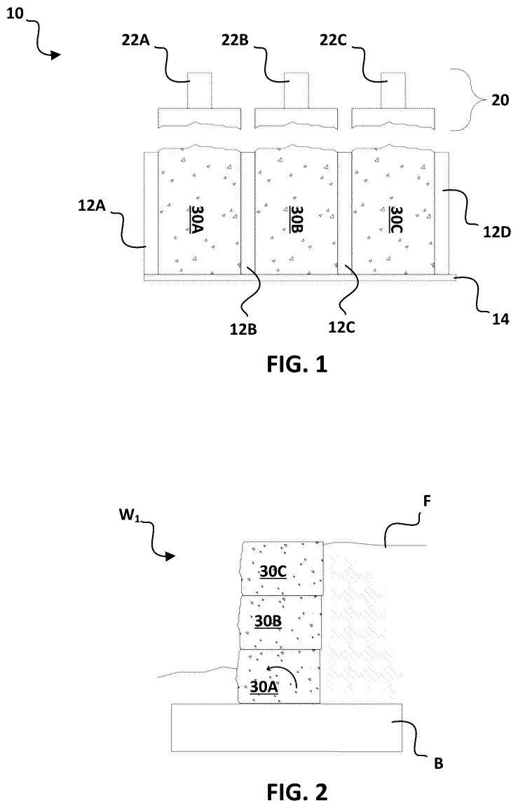

FIG. 1 is a side cutaway view of a retaining wall block mold 10 being used to form retaining wall blocks 30A, 30B, 30C. Partitions 12A, 12B, 12C, and 12D are spaced from each other in the mold cavity to subdivide the mold cavity into areas for the concrete to be introduced thereby to form blocks 30A, 30B, and 30C. A production board 14 is positioned at the bottom end of the mold to provide a lowermost extent to the blocks 30A, 30B, 30C, and to provide a location for the blocks, once formed, to rest during curing. A press head system 20, in this embodiment having three individual press heads 22A, 22B, 22C, can be moved down against the introduced concrete so as to press down on the concrete within the individual mold cavity subdivisions thereby to compress the concrete and also provide, in this embodiment, a texture to each of blocks 30A, 30B, 30C.

FIG. 2 is a first side view of a retaining wall W₁ for retaining a fill F (such as soil, gravel, and the like) and formed using retaining wall blocks 30A, 30B, 30C. In particular, when blocks, such as blocks 30A, 30B, 30C, are placed or stacked as wall W₁, they are first rotated 90 degrees from their orientation in the mold 10 (and, depending on how they are packaged and shipped, from their orientation on a skid) and stacked on a base B, such as on suitably prepared and levelled ground.

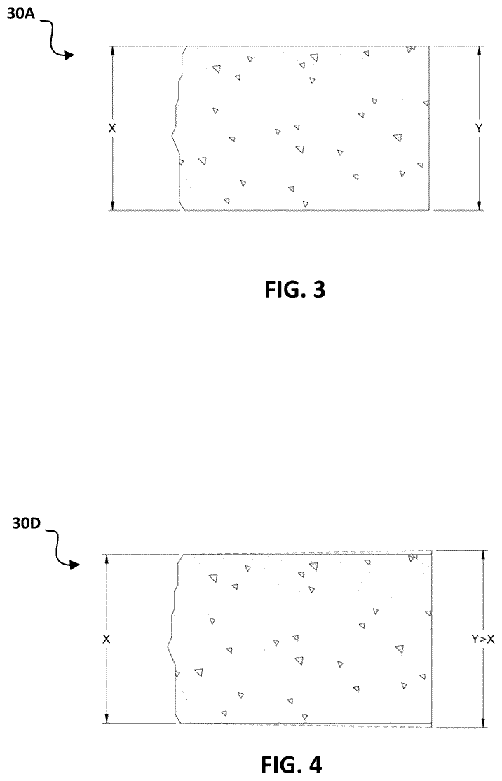

FIG. 3 is a first side view of retaining wall block 30A, in isolation. It will be appreciated that, when stacking blocks as shown in FIG. 2, it is important for the integrity of the wall that the vertical height X at the front of block 30A is the same as the vertical height Y at the rear of block 30A. If these dimensions are not identical, and instead differ even by very small amounts such as 2-3 millimetres (mm), the side profile of block 30A will take on a wedge shape. FIG. 4 is a first side view of retaining wall block 30A in isolation and showing its rear side having a greater vertical height than its front side, thereby assuming the wedge shape.

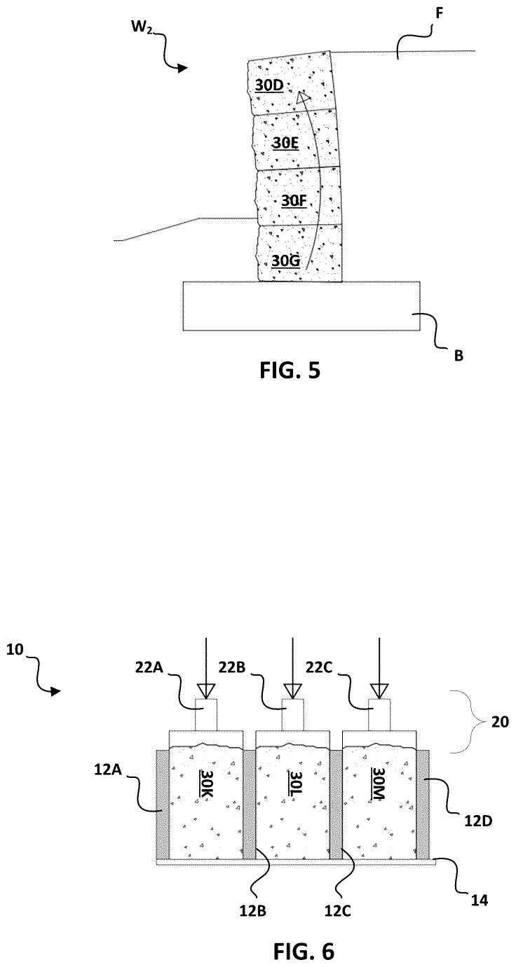

FIG. 5 is a first side view of a retaining wall W₂ formed using several front-rear wedged retaining wall blocks of FIG. 4. As can be seen, these blocks 30D, 30E, 30F and 30G are not level and will cause the wall to rotate forward more and more with each stacked course. This causes the wall W₂ to be structurally unstable and visually unappealing.

For structural purposes, concrete blocks are often required to be at least 250-300 mm in front side to back side depth when used to form a retaining wall. In a mold, this “depth” corresponds to the vertical height of the block when in a face-up orientation, as explained above. The process of dry-cast concrete forming has the benefit of very fast production of the molded blocks based on the use of a low water content in the concrete mix and then removing the mold from the blocks almost immediately after the concrete is filled, formed, and compacted. In a typical case, the concrete may only be in the mold from about 15-40 seconds before the mold is lifted off of or otherwise away from the blocks. The just-formed, but not cured, or “green”, concrete blocks are left to stand freely on production board 14 without support.

This method of manufacturing whereby concrete units are left to stand freely without support was originally developed many years ago for paving stone and was, over time, adapted for larger retaining wall blocks. Since paving stones are relatively short in depth (60-70 mm typically), the dry-cast method works well, and the green concrete maintains its vertical alignment easily. However, as the concrete units become taller, due to the correspondingly greater weight, even with a relatively dry mixture, the units may undergo a certain amount of slump or widening at the bottom before the concrete has a chance to set-up or cure on the production board 14.

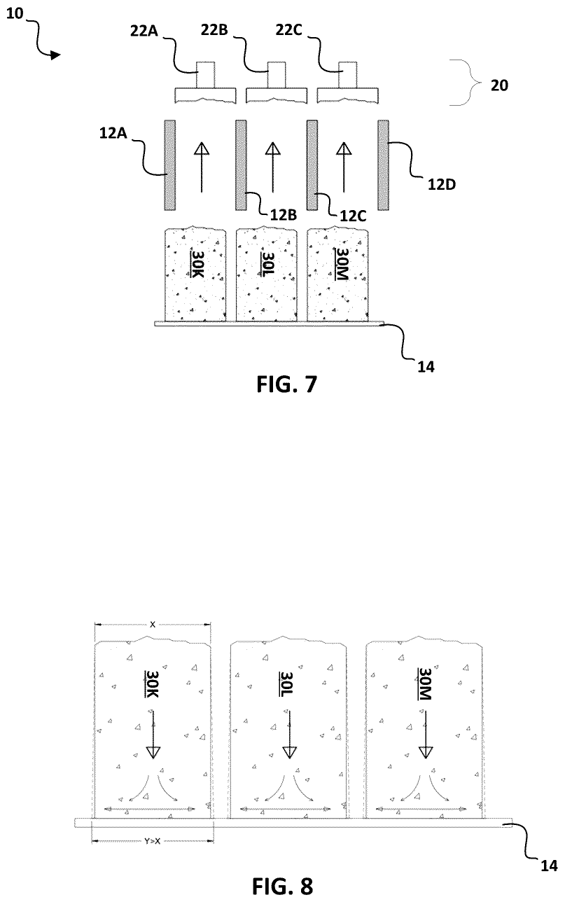

As explained above, it is common to place dry concrete mixture into the mold cavities and compact it under high pressure and vibration with press heads. FIG. 6 is a first side cutaway view of retaining wall block mold 10 being used to form retaining wall blocks 30K, 30L, 30M, showing pressures imparted on front faces of the blocks 30K, 30L, 30M by individual press heads 22A, 22B, 22C of compacting press head system 20.

After a cycle time of (typically) between about 15 and about 45 seconds, the mold 10 is lifted upwards and the green concrete product remains on production board 14. FIG. 7 is a first side cutaway view the retaining wall block mold 10, with compacting press head system 20 being lifted and inter-block partitions 12A, 12B, 12C, and 12D being lifted from between newly-formed blocks 30K, 30L, 30M. Depending on the mix design and height of the blocks 30K, 30L, 30M, the self-weight of the uncured concrete could cause some malformation such as slumping or widening at the bottom. This is shown in FIG. 8. In the industry this is sometime referred to as “elephant feet”, with the face dimension (X) being smaller than the back dimension (Y>X).

It may be that additional features are required in a retaining wall block to facilitate an interlock between units. This may be done to provide a set wall batter (or “lean”), and to provide for interblock shear strength in a wall. When providing such features, such as in the form of tongues and grooves, a different phenomenon may occurs which can also lead to malformation, in particular bulging of concrete towards the bottom of the block.

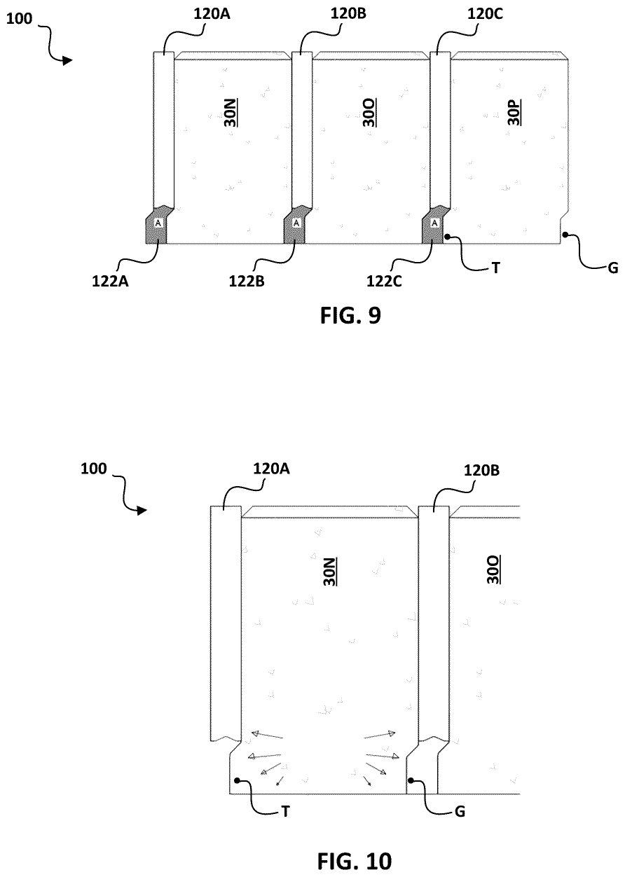

FIG. 9 is a first side partial view of a retaining wall block mold 100, having partitions 120A, 120B, and 120C, and insert members 122A, 122B, and 122C, for forming a vertical interlock system in respective retaining wall blocks 30N, 30O, 30P. Such a vertical interlock system, in this embodiment, may include a tongue in a bottom side of the block (such as tongue T in block 30P as shown) and a corresponding groove in a top side of the block (such as groove G in block 30P as shown).

As these tongue T and groove G features are formed as undercuts when a block is formed face-up (that is, they are off-plane with the partitions 120A, 120B, 120C), they would interfere with the entire mold being vertically ejected to leave the blocks 30N, 30O, 30P. As such, the removable insert members (or “draw fingers”) 122A, 122B, 122C are used in conjunction with corresponding ones of the partitions 120A, 120B, 120C and can be slid laterally in and out of mold 100 while partitions 120A, 120B, 120C, and the mold box can be lifted vertically. Generally, the sequence for removing the mold is to first remove the insert members 122A, 122B, 122C and then remove the mold box including the partitions 120A, 120B, and 120C.

As discussed, once the mold 100 is filled with concrete, tremendous compaction/vibration pressure is applied to the concrete using the press heads (not shown in FIG. 9). While such forces are contained, they build up within the subdivided mold cavity. When the insert members 122A, 122B, 122C are removed very rapidly, and before the partitions 120A, 120B, 120C are lifted, there can be a release of the compaction stresses at the portions of the faces of the blocks that had been adjacent to the insert members 122A, 122B, 122C. FIG. 10 is a magnified first side partial view of the retaining wall block mold 100, showing distribution of pressures that may tend, pre-curing once at least insert members have been removed, to cause concrete to be malformed, in particular to bulge and/or slump, at locations along the top and bottom sides of the retaining wall block (to the right and left, respectively, of mold 100) and also to be malformed, in particular to bulge and/or slump, towards a rear side of the block (towards the bottom of the mold).

It is estimated that these forces would be the highest in the direction perpendicular to the vertical sidewall of the blocks and lowest as they radiate toward the bottom of the block (adjacent to production board 14) as this is a supportive surface.

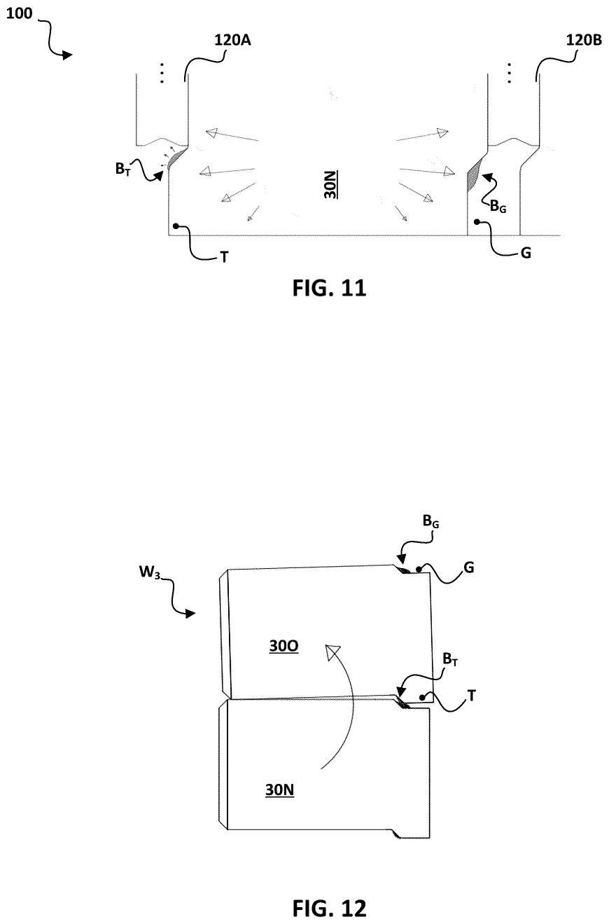

As a result of this release of pressures within the cavity, trials have shown that a malformation
a kind of bulge B_{T} in particular—manifested in the tongue T area closest to the interface between the partition 120A and the insert member 122A at the front side of the block. Also, another malformation
a kind bulge B_{G} in particular—manifested in the groove G area closest to the interface between the partition 120A and the insert member 122A at the bottom side of the block. FIG. 11 is a magnified first side partial view of the retaining wall block mold 100, showing the common locations at which bulge malformation B_{T} and B_{G} was found to occur. It was observed that such bulge malformations B_{T} and B_{G} did not always occur in a given block, or did not always both occur in a given block. However, the system was indeed susceptible to them.

While these bulges B_{T} and B_{G} released the stresses and pressure that built up during compaction, they resulted in blocks that did not bear flat or level when stacked. FIG. 12 is a first side view of a retaining wall W₃ formed using retaining wall blocks in which the bulge malformations depicted in FIG. 11 had occurred. Wall W₃ might continue to over-rotate course over course as blocks such as blocks 30O and 30N continued to be stacked, leading to structural and aesthetic problems because such blocks could not generally be relied upon to lie flat atop each other to create a vertical or battered wall.

In accordance with an aspect of the following, to mitigate for the malformations—that is, to reduce their likelihood of occurring at all but also to, if they should occur, control their impacts such that controllably-malformed blocks can still be used effectively in a structural, aesthetically proper retaining wall—a female (or concave) arch is incorporated into particular locations along sides of the block. Each female arch may be referred to interchangeably herein as a “pressure dissolution arch”, or PDA. Each PDA provides increased resistance to bulge malformation at its respective location along the blocks. However, as a concave arch, each PDA is additionally useful for directing bulging that might occur, if the resistance should be overcome. For example, the negative space accorded by the concavity can provide a kind of “failsafe” in the event bulging does occur, by providing the bulging material with a region into which to protrude instead of immediately extending beyond the block envelope to where it could interfere with the block's ability to sit flat and interlock with other adjacent blocks. Also, the PDAs may reduce the mass of concrete required to form a functional interlocking retaining wall block. Furthermore, PDAs may provide a region into which occasionally extraneous portions formed on an adjacent block—such as minor burr formed along an edge of the adjacent block due perhaps to a minor offset between a partition and an insert member or a failure of the partition to fully seat against the insert member during molding of a particular batch of blocks—can be received thereby to allow the very slightly-malformed adjacent block to sit flat.

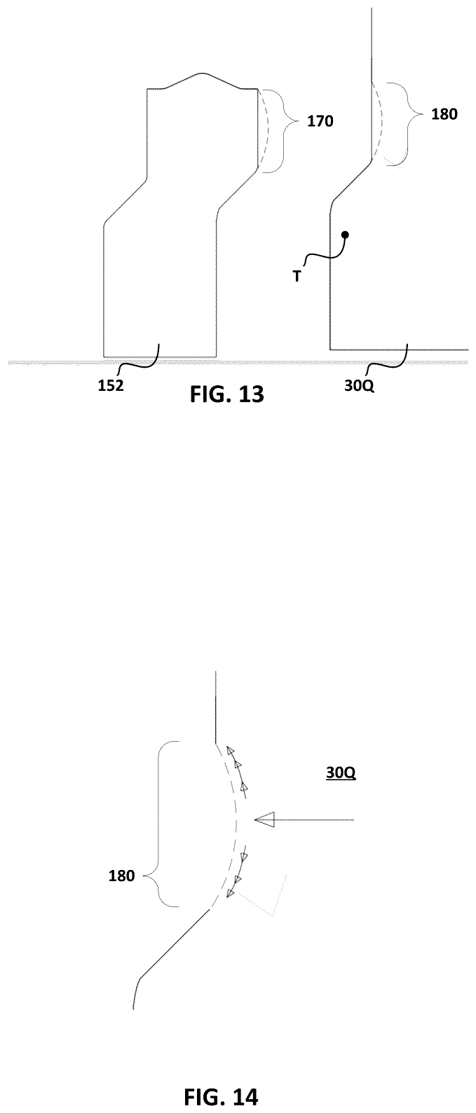

Embodiments will now be described. FIG. 13 is a first side view of an insert member 152 of a mold. Insert member 152 is configured to present an offset with respect to a corresponding partition (not shown), thereby to create a groove in a block to be molded to the left of it (that block not shown), and a tongue in a block to be molded to the right of it (that block being block 30Q in FIG. 13). Insert member 152 has a feature 170 (shown in dashed line for contrast) for forming a corresponding PDA 180 (shown in dashed line for contrast) in a bottom side of an interlocking retaining wall block 30Q. Due to the strength imparted by an arched structure as opposed to a planar wall, PDA 180 may better resist malformation such as bulge and slump than would a planar wall, while block 30Q cures in a face-up orientation after mold components (not shown, except for insert member 152) have been removed.

FIG. 14 is a magnified partial first side view of PDA 180 formed in the bottom side of block 30Q for resisting malformation such as bulge and slump and showing, with arrows, a distribution of weight pressures across PDA 180.

It will be observed that, in this embodiment, feature 170 (and thus PDA 180) would be located at a position corresponding to the vertically highest point of insert member 152 and just above the offset feature in insert member 152 that forms the tongue T. The provision of feature 170 at the highest point of insert member 152 is done with the recognition that the insert member 152 is removed from the mold box first, thus first providing the potential outlet for compaction stress in the concrete to be relieved. Therefore, while PDA 180 is not itself part of the interlocking tongue T, and so as to enable tongue T itself to maintain integrity, the vertical height of insert member 152 is higher than the tongue-creating feature by the amount of the vertical height feature 170.

While PDA 180 may, in some blocks being formed, entirely resist collapse (this being a function of the concrete mix, the pressures applied during molding, the depth of the blocks, and other physical factors), collapse may be permitted to occur in a manner so as not to interfere with the blocks' ability to sit flat and interlock with adjacent like blocks. It has been determined that approximately 2-5 mm of bulge due to at least partial collapse of PDA 180 may occur in a range of situations. Therefore, feature 170 forming PDA 180 is dimensioned to provide a concavity large enough to receive the bulge while ensuring the bulge does not cross the envelope of the block, in particular crossing a plane of influence extending between the top/bottom surfaces.

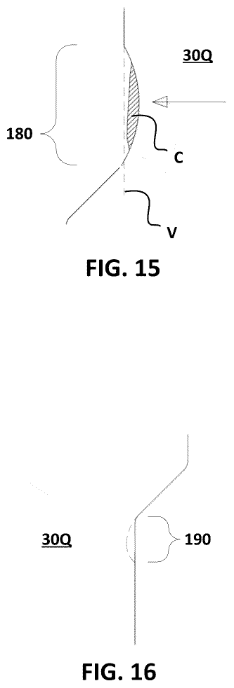

FIG. 15 is a magnified partial first side view of PDA 180 formed in the bottom side of block 30Q, and showing a partial collapse C of PDA 180 due to pressure overcoming the resistance of the arch of PDA 180. It can be seen that, due to the size of PDA 180, collapse C remains within the region of the arching and, in particular, does not cross vertical plane V, drawn in FIG. 15 to be representative of the local portion of the envelope of block 30Q. As such, even though malformation has occurred, it has been mitigated due to the region of PDA 180 into which it has protruded, and has not extended beyond the envelope of block 30Q. Thus, although collapse C has occurred despite the resistance of PDA 180, collapse C cannot significantly interfere with the ability of block 30Q to sit flat and interlock with adjacent like blocks. Even if collapse C were to extend slightly beyond vertical plane V in a given block, the bulk of the bulge would have been taken up within the concavity thus significantly mitigating the interference that collapse C might represent.

It may be considered therefore that the PDA 180 works in two ways. Firstly, the arch naturally has certain amount of strength through its inherent geometry to distribute the residual compaction forces/stresses along its length and dissipate them into the abutting volumes of concrete, as contrasted with directly “out” or perpendicular to the vertical face. Secondly, if the arch does collapse under pressure, the negative volume that is provided by the concavity is sufficient to allow a certain amount of bulging without problematically crossing the envelope (represented locally by vertical plane V) of the block to interfere with the placement of the block.

FIG. 16 is a first side view of a portion of a bottom side of interlocking retaining wall block 30Q showing a location at which a PDA 190 at the rearward portion of the bottom side of block 30Q may be located. It has been discovered that the highest position immediately rearward of the sloped is a most useful location for a PDA 190. It will be appreciated that, in this embodiment, PDA 190 is shorter in vertical height than PDA 180 on the other side of block 30Q, and has a smaller arch height. Variations are possible.

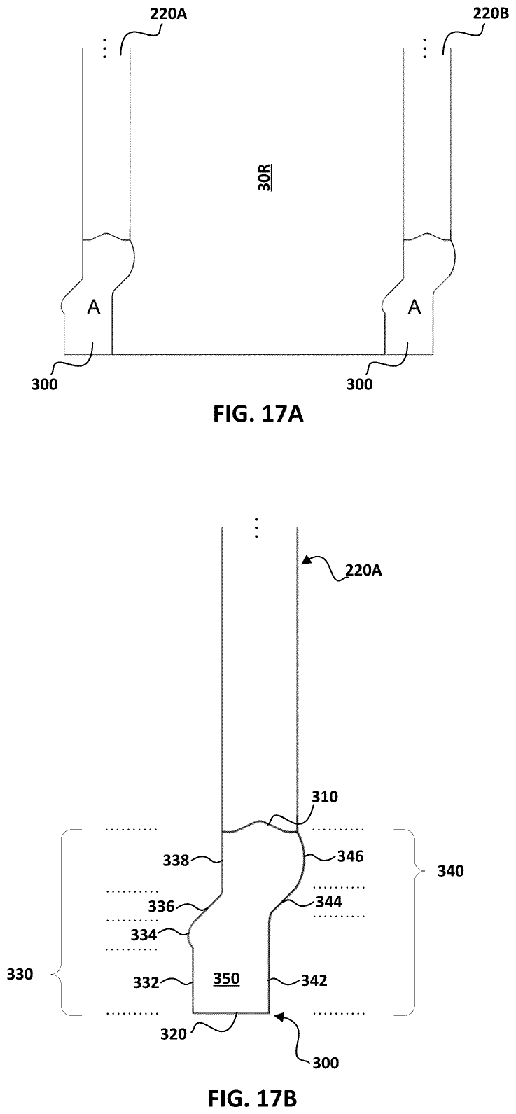

FIG. 17A is a first side view of insert members 300 of a mold having features for forming corresponding interlocking and PDA features in both a top side and a bottom side of an interlocking retaining wall block 30R. The PDA features may resist malformation such as bulge and/or slump at the rearward portion of block 30R while block 30R cures in a face-up orientation after mold components such as insert members 300 and/or respective partitions 220A, 220B have been removed. Testing has indicated that a PDA 180 and a PDA 190 on respective bottom and top sides of a block, such as block 30R, also allows a path for potential slump to move, thus mitigating malformation due to both bulge and slump.

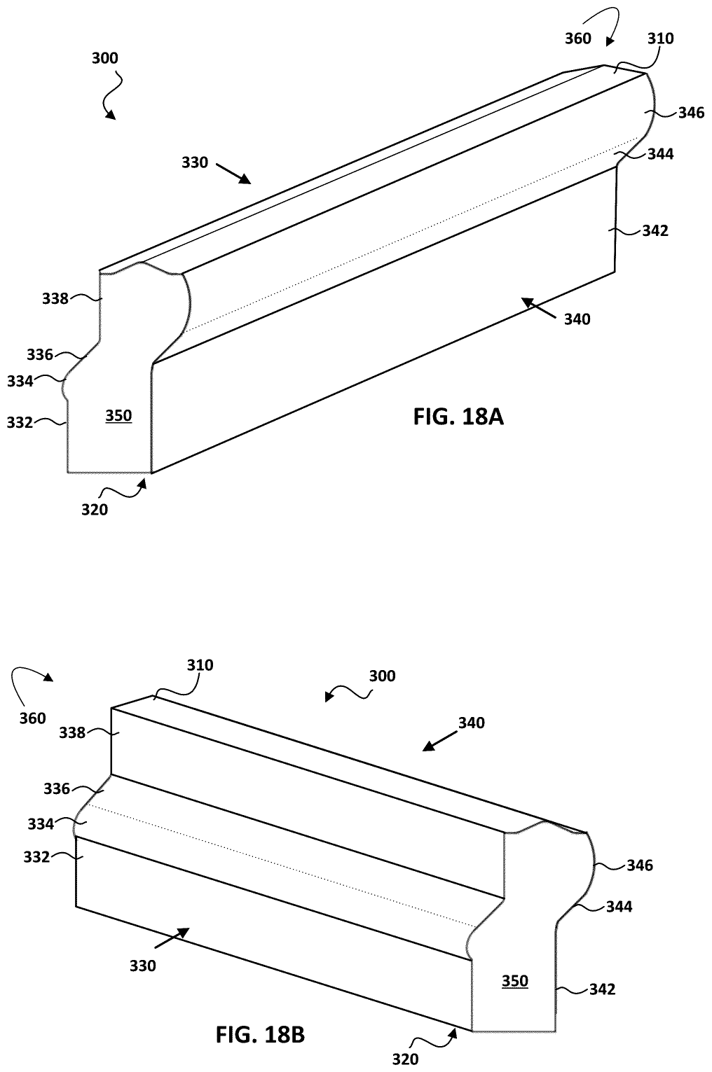

FIG. 17B is a magnified first side view of insert member 300 and its respective partition 220A, according to an embodiment. FIG. 18A is a rear side perspective view of insert member 300, and FIG. 18B is a front side perspective view of insert member 300.

In this embodiment, insert member 300 includes an insert body having a top side 310 and a bottom side 320 opposite top side 310, a front side 330 and a rear side 340 opposite front side 330, and a first side 350 and a second side 360 (not shown in FIG. 17B) opposite first side 350. In this embodiment, top side 310 has a male peaked configuration that mates with a female peaked configuration in the corresponding partition 220A, thereby to ensure insert member 300 and partition 220A are properly laterally aligned when they are seated against each other within the mold.

In this embodiment, front side 330 of the insert body includes a front wall extending between first side 350 and second side 360. The front wall has, in seriatim from bottom side 320 to top side 310, a vertical first front wall portion 332, then a convexly-arched vertical second front wall portion 334, then a rearwardly-oblique (i.e. ramped up and to the right in FIG. 17B) third front wall portion 336, and then a vertical fourth front wall portion 338. It is the convexly-arched vertical second front wall portion 334 that forms a corresponding (convexly-arched) PDA 190 in a top side of a block being formed to the left of insert member 300.

Furthermore, it is rearwardly-oblique third front wall portion 336 that forms a corresponding (ramped) transition into a groove in the top side of block being formed to the left of insert member 300, and vertical first front wall portion 332 that forms the remainder of the groove to terminate at the rear side of the block (corresponding to the bottom side 320 of insert member 300).

Convexly-arched vertical second front wall portion 334 is referred-to as vertical since, though arched, it extends generally vertically as does, for example, vertical first front wall portion 332, such that PDA 190 that it forms “faces” towards sources of pressure from within the block so as to direct them along the arch and, in the event of a collapse, so that the resulting bulge can primarily remain within the concavity and thus envelope of the block.

Also in this embodiment, rear side 340 of the insert body includes a rear wall extending between first side 350 and second side 360. The rear wall has, in seriatim from bottom side 320 to top side 310, a vertical first rear wall portion 342, then a rearwardly-oblique (i.e. ramped up and to the right) second rear wall portion 344, and then a convexly-arched vertical third rear wall portion 346. It will be noted that second rear wall portion 344 is parallel to third front wall portion 336. It is the convexly-arched vertical third rear wall portion 346 that forms a corresponding (convexly-arched) PDA 180 in a bottom side of a block being formed to the right of insert member 300.

Furthermore, it is rearwardly-oblique second rear wall portion 344 that forms a corresponding (ramped) transition of a tongue protruding from the bottom side of block being formed to the right of insert member 300, and vertical first rear wall portion 342 that forms the remainder of the tongue to terminate at the rear side of the block (corresponding to the bottom side 320 of insert member 300).

Convexly-arched vertical third rear wall portion 346 is referred-to as vertical since, though arched, it extends generally vertically as does, for example, vertical first rear wall portion 342, such that PDA 180 that it forms “faces” towards sources of pressure from within the block so as to direct them along the arch and, in the event of a collapse, so that the resulting bulge can primarily remain within the concavity and thus envelope of the block.

In this embodiment, the front wall and the rear wall have the same vertical height. Alternatives are possible, as will be described herein.

In this embodiment, each of the vertical first front wall portion 332, the rearwardly-oblique third front wall portion 336, the vertical fourth front wall portion 338, the vertical first rear wall portion 342, and the rearwardly-oblique second rear wall portion 344, is planar. Alternatives are contemplated in which one or more of these wall portions are non-planar but have features that allow them to present functionally as planar for the purpose of interfacing with an adjacent like block in a retaining wall. As such, certain of these wall portions may be arched or castellated, or otherwise non-continuous or partially or fully non-planar in such a manner that still enables them to be supported by and/or to support an adjacent retaining wall block in a structurally and aesthetically appropriate retaining wall.

In this embodiment, third rear wall portion 346 is convexly-arched to a maximum extent of about 5 millimetres (mm) from a vertical plane passing through its ends (see, for example, vertical plane V in FIG. 15), thereby to form in a block a PDA 180 of sufficient size to accommodate a potential collapse C resulting in a bulge of the same extent, without protrusion beyond the block envelope. However, in alternative embodiments, such maximum arch extents may differ, such as being as low as about 2 mm, or at some extents in between, such as about 3 mm or 4 mm. Greater or lesser arch extents may be provided in alternative blocks, such as 6 mm, 7 mm, or 1 mm.

In this embodiment, as will be explained further below, the vertical height of first rear wall portion 342 is greater than the combined vertical heights of first front wall portion 332 and convexly-arched vertical second wall portion 334, thereby to provide formed blocks with front-rear offset tongues and grooves. This enables the blocks, when stacked, to form a “battered” (i.e., leaning, or sloped) wall. Providing a batter may provide more structural stability for resisting the pressure applied by a fill F.

It may alternatively be desirable or necessary in certain construction situations to provide a wall without batter. That is, to provide a substantially vertical wall. For example, a space constraint may present itself in a given wall design such that lean or batter in a wall could take up too much room on site. It will be appreciated therefore, that more or less of an offset, or no offset (for a non-battered—i.e. vertical—wall), may be provided by adjusting the relative vertical heights of the above-described wall portions.

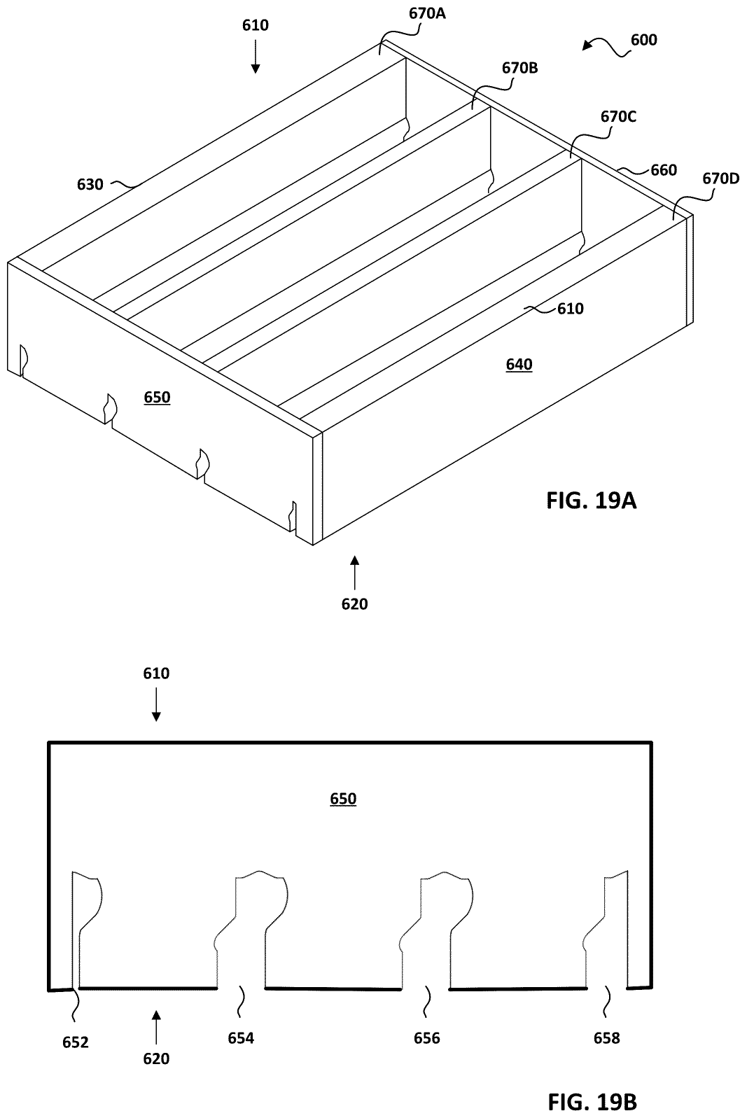

A retaining wall block may be formed using a mold that includes the insert member 300 described herein, or that contains alternative configurations of insert members as contemplated herein. Components of one such mold, according to an embodiment, are shown in FIG. 19A, which is a top perspective view of a mold having a mold box 600 and partitions 670A, 670B, 670C, 670D each with features for cooperating with insert members such as that shown in FIG. 17B to form respective blocks. FIG. 19B is a first side view of a first side 650 of mold box 600.

In this embodiment, the mold of FIGS. 19A and 19B is suitable for manufacturing multiple interlocking dry-cast concrete retaining wall blocks. As will be described, the blocks each have a top side having a transverse profile including at least one interlocking structure projecting from or recessed into the top side, and a bottom side having a transverse profile including at least one complementary interlocking structure recessed into or projecting from the bottom side. When being molded within mold box 600, they are formed “face-up”, and so their front sides correspond to the top side of mold box, as shown in the figures.

Mold box 600 includes first side wall 650 and second side wall 660 opposite first side wall 650, each joined to front wall 630 and rear wall 640 opposite front wall 630, to define a mold cavity. The mold cavity has a substantially open top face at a top side 610 of mold box 600, and a substantially open bottom face at a bottom side 620 of mold box 600. Partitions 670A-B are configured to define a space between adjacent blocks or a space between a block and either the front side 610 or rear side 620 (i.e., end walls) of mold box 600, extending substantially parallel to the end walls substantially from the top face into the mold cavity. At least a longitudinal portion of partitions 670A-D are configured to form, without interlocking in a vertical direction with, a first transverse portion of the profile of the top side of one block or a first transverse portion of the profile of the bottom side of an adjacent block, or both. These first transverse portions do not include any undercut portion that would impede vertically lifting mold box 600 including partitions 670A-D off of molded blocks.

Removable insert members 300 (not shown in FIGS. 19A and 19B) are provided individually or in one or more groups as part of a respective removable insert. As described herein, each insert member 300, when positioned in the mold box in vertical correspondence with respective ones of the partitions 670A-D, extend substantially parallel to end walls 610, 620 and are configured to occupy the space between adjacent blocks, or the space between a block and either the front side 610 or rear side 620 of mold box 600, for forming a remaining transverse portion of the profile of the top side of one block or a remaining transverse portion of the profile of the bottom side of an adjacent block, or both. At least one of the partitions and a corresponding insert member for forming both the transverse portion of the profile of the top side of one block and the transverse portion of the profile of the bottom side of an adjacent block together form a combined body. This combined body, for example, would be formed by the coming together of partition 670B and insert member 300 in the mold box. The combined body is the same as that shown front the first side in FIG. 17B, and includes a front wall extending between first and second sides of the combined body and having, in seriatim from the bottom side to the top side of the mold box, a vertical first front wall portion, a convexly-arched vertical second front wall portion, a rearwardly-oblique third front wall portion, and a vertical fourth front wall portion. It will be appreciated that the vertical fourth front wall portion of the combined body is formed partly by fourth front wall portion 338 of the front side of insert member 300 and partly by the frontward-facing side of partition 220A.

The combined body also includes a rear wall opposite the front wall, the rear wall extending between the first and second sides of the combined body. The rear wall includes, in seriatim from the bottom side to the top side of the mold box, a vertical first rear wall portion, a rearwardly-oblique second rear wall portion, the second rear wall portion parallel to the third front wall portion, a convexly-arched vertical third rear wall portion, and a vertical fourth rear wall portion. It will be appreciated that, in this embodiment, the vertical fourth rear wall portion of the combined body is formed entirely by the rearward-facing side of partition 220A.

In FIG. 19B, a first side wall 650 of mold box 600 includes openings 652, 654, 656, and 658 formed therethrough for permitting respective insert members to pass laterally through to interface with respective partitions, and to be removed once blocks are formed. For example, insert members 300 would be able to pass through correspondingly-shaped openings 654 and 656 for each forming a top surface of a respective block to their left, and the bottom surface of a respective different block to their right. An alternative insert member (not shown) would be shaped to pass through correspondingly-shaped opening 652 for forming the bottom surface of a respective block to its right, and another alternative insert member (also not shown) would be shaped to pass through correspondingly-shaped opening 658 for forming the top surface of a respective block to its left. The insert members themselves may have a first side profile that tightly corresponds with the profile of respective ones of the openings 652, 654, 656, 658, thereby to block openings when inserted therethrough and keep fluid concrete from seeping through under pressure. Alternatively, if there is a marginal size different, other structures may be included to block the egress of fluid concrete.

Retaining wall blocks formed using the mold described and depicted herein will have features corresponding to those imparted by the mold. However, features of two retaining wall blocks formed using the mold may slightly differ. In particular, a PDA in some retaining wall blocks may hold, having fully resisted collapse despite the pressure, whereas the same PDA may have at least partially collapsed in others because of the pressure. This difference may be a result of differing physical conditions such as the nature of the concrete mix, the amount of pressure imparted during molding, and other physical factors. However, because of the format of the PDA, two such differing retaining wall blocks may be entirely compatible to be stacked and to interlock because the collapse occurring in the one has not breached its envelope.

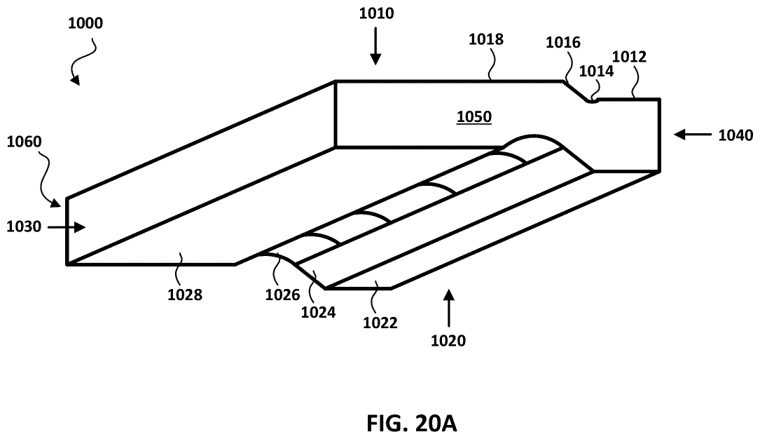

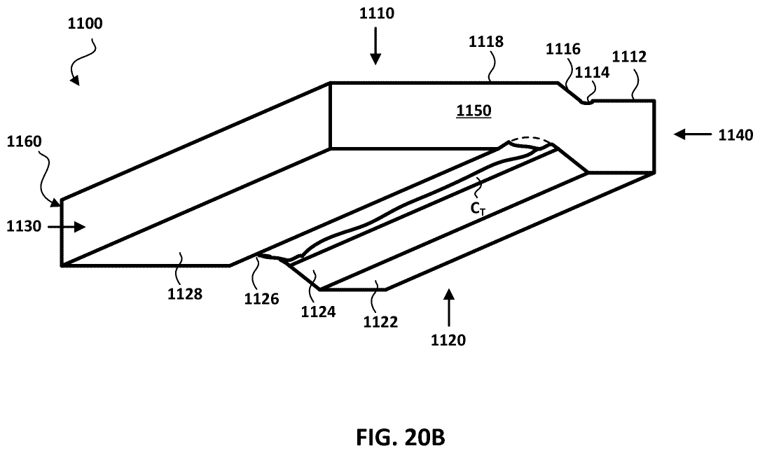

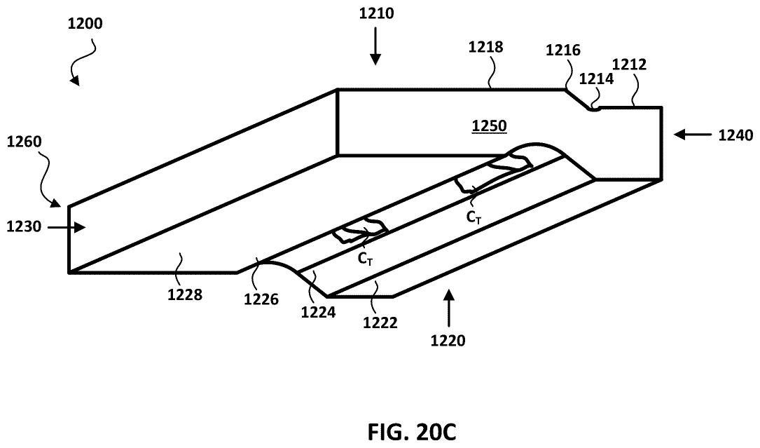

FIG. 20A is a first side view of a retaining wall block 1000 formed using a mold such as that shown in FIG. 19A. Retaining wall block 1000 includes a block body having a top side 1010 and a bottom side 1020 opposite top side 1010, a front side 1030 and a rear side 1040 opposite front side 1030, and a first side 1050 and a second side 1060 opposite first side 1050. In this embodiment, bottom side 1020 has, in seriatim from rear side 1040 to front side 1030, a horizontal first bottom side portion 1022, an upwardly-oblique second bottom side portion 1024, a concavely-arched horizontal third bottom side portion 1026, and a horizontal fourth bottom side portion 1028. Also in this embodiment, top side 1010 has, in seriatim between rear side 1040 and front side 1030, a horizontal first top side portion 1012, a concavely-arched horizontal second top side portion 1014, an upwardly-oblique third top side portion 1016, and a horizontal fourth top side portion 1018. Third top side portion 1016 is parallel to second bottom side portion 1024.

In this embodiment, no even partial collapse of concavely-arched horizontal third bottom side portion 1026 or of concavely-arched horizontal second top side portion 1014 has occurred between molding and curing.

FIG. 20B is a first side view of an alternative retaining wall block 1100 formed using a mold such as that shown in FIG. 19A. Retaining wall block 1100 includes a block body having a top side 1110 and a bottom side 1120 opposite top side 1110, a front side 1130 and a rear side 1140 opposite front side 1130, and a first side 1150 and a second side 1160 opposite first side 1150. In this embodiment, bottom side 1120 has, in seriatim from rear side 1140 to front side 1130, a horizontal first bottom side portion 1122, an upwardly-oblique second bottom side portion 1124, a partially-collapsed concavely-arched horizontal third bottom side portion 1126 showing controlled bulge due to collapse CT, and a horizontal fourth bottom side portion 1128. Also in this embodiment, top side 1110 has, in seriatim between rear side 1140 and front side 1130, a horizontal first top side portion 1112, a concavely-arched horizontal second top side portion 1114, an upwardly-oblique third top side portion 1116, and a horizontal fourth top side portion 1118. Third top side portion 1116 is parallel to second bottom side portion 1124.

In this embodiment, a partial collapse of concavely-arched horizontal third bottom side portion 1126 has occurred between molding and curing. The partial collapse amounts substantially to a partially-collapsed concavely-arched horizontal region extending the entire extent between first side 1150 and second side 1160 of retaining wall block 1100. However, the partial collapse has been contained within its concavity and thus within the envelope of retaining wall block 1130. In this embodiment, no even partial collapse of concavely-arched horizontal second top side portion 1114 has occurred between molding and curing. As such retaining wall block 1100 could be properly stacked and interlocked with another like block and/or with retaining wall block 1000 described above.

FIG. 20C is a first side view of an alternative retaining wall block 1200 formed using a mold such as that shown in FIG. 19A. Retaining wall block 1200 includes a block body having a top side 1210 and a bottom side 1220 opposite top side 1210, a front side 1230 and a rear side 1240 opposite front side 1230, and a first side 1250 and a second side 1260 opposite first side 1250. In this embodiment, bottom side 1220 has, in seriatim from rear side 1240 to front side 1230, a horizontal first bottom side portion 1222, an upwardly-oblique second bottom side portion 1224, a partially-collapsed concavely-arched horizontal third bottom side portion 1226 showing multiple controlled bulges due to collapse CT, and a horizontal fourth bottom side portion 1228. Also in this embodiment, top side 1210 has, in seriatim between rear side 1240 and front side 1230, a horizontal first top side portion 1212, a concavely-arched horizontal second top side portion 1214, an upwardly-oblique third top side portion 1216, and a horizontal fourth top side portion 1218. Third top side portion 1216 is parallel to second bottom side portion 1124.

In this embodiment, a partial collapse of concavely-arched horizontal third bottom side portion 1226 has occurred between molding and curing. The partial collapse amounts substantially to, along the extent between first side 1250 and second side 1260 of retaining wall block 1200, multiple partially-collapsed concavely-arched regions CT and multiple substantially concavely-arched regions interspersed therebetween. However, the partial collapse has been contained within the concavity and thus within the envelope of retaining wall block 1230. In this embodiment, no even partial collapse of concavely-arched horizontal second top side portion 1214 has occurred between molding and curing. Retaining wall block 1200 could be properly stacked and interlocked with another like block and/or with retaining wall block 1000 and/or with retaining wall block 1100 described above.

The differing collapsing occurring in retaining wall blocks 1100 and 1200 have been shown as examples of the various kinds of partial collapsing of PDA on the bottom side of the retaining wall block that may be permitted to occur while producing a functional retaining wall block. While not shown by way of examples, it will be appreciated that various kinds of partial collapsing may also be resisted but nonetheless permitted occur in the PDA on the top side of a retaining wall block.

It will be appreciated that, in other block embodiments formed using a mold such as that shown in FIG. 19A, full collapse of a concavely-arched horizontal third bottom side portion or a concavely-arched horizontal second top side portion may occur, at least in some regions along their respective extents, thereby to result in substantial flattening instead of any arching being manifest in the final product of a given block or a given batch of blocks. As such, one may find, in a set of multiple retaining wall blocks formed in accordance with the principles disclosed herein, at least one block having a fully concavely-arched horizontal third bottom surface portion, and at least one block having an at least partially-collapsed concavely-arched horizontal third bottom surface portion. Similarly, one may find, in a set of multiple retaining wall blocks formed in accordance with the principles disclosed herein, at least one block having a fully concavely-arched horizontal second top surface portion, and at least one block having an at least partially-collapsed concavely-arched horizontal second top surface portion.

While retaining wall blocks in a given set of retaining wall blocks may have been formed using the methods, molds and insert members disclosed herein, the PDAs in particular may not be manifest in any of the retaining wall blocks because the conditions have been set by operators such that malformations in a particular batch due to expected collapse have actually resulted in complete fill, but not overfill, of the concavities formed by the PDAs. That is, the malformations may be controlled using PDAs and physical conditions for the mold box described herein such that a given cured retaining wall block may appear as though it had been formed without any convexly-arched portions of an insert member, when it fact it had been.

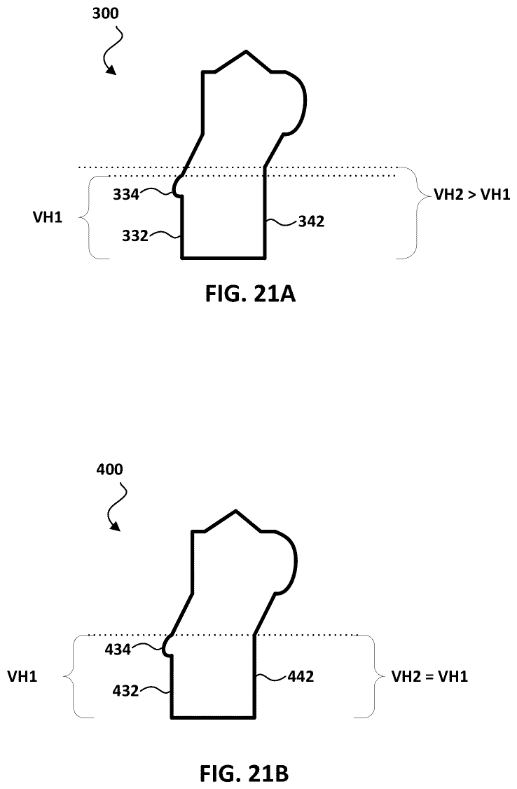

FIG. 21A is a first side view of the insert member 300, showing relative configurations of front wall portions 332 and 334 and rear wall portion 342 for forming corresponding blocks that can be stacked in interlocking configuration to form a battered retaining wall. In particular, as discussed briefly above, the vertical height VH2 of the vertical first rear wall portion 342 is greater than the combined vertical height VH1 of the vertical first front wall portion 332 and the convexly-arched vertical second front wall portion 334.

FIG. 21B is a first side view of an alternative insert member 400, similar to insert member 300, but showing relative configurations of front wall portions 432, 434 and rear wall portion 442 for forming corresponding blocks that can be stacked in interlocking configuration to form a vertical, or “non-battered” retaining wall. In particular, the vertical height VH2 of the vertical first rear wall portion 442 is the same as the combined vertical height VH1 of the vertical first front wall portion 432 and the convexly-arched vertical second front wall portion 434.

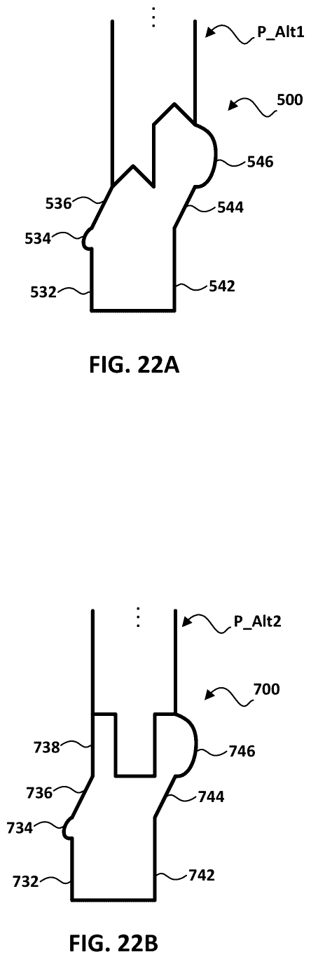

FIG. 22A is a first side view of another alternative insert member 500 and corresponding partition P_Alt1. The shapes and interrelationships between insert member 500 and partition P_Alt1 differ from that of insert member 300 and its corresponding partition. However, the combined body of insert member 500 and partition P_Alt1 provide the same combinations of front wall portions and rear wall portions that are provided by the combined body of insert member 300 and its corresponding partition. They thereby provide structures for molding the same blocks, such as the blocks shown in FIGS. 20A-C.

In this embodiment, however, in contrast to insert member 300, insert member 500 does not itself have a vertical fourth front wall portion. That is, the frontward-facing wall of partition P_Alt1 extends downwards to terminate adjacent to a rearwardly-oblique third front wall portion 536. As such, the front side of the insert body of insert member 500 includes a front wall extending between first and second sides, and has, in seriatim from its bottom side to its top side, a vertical first front wall portion 532, then a convexly-arched vertical second front wall portion 534, and then a rearwardly-oblique (i.e. ramped up and to the right in FIG. 22A) third front wall portion 536. The rear side of the insert body of insert member 500 includes a rear wall extending between its first and second sides, and has, in seriatim from the bottom side to the top side, a vertical first rear wall portion 542, then a rearwardly-oblique (i.e. ramped up and to the right) second rear wall portion 544, and then a convexly-arched vertical third rear wall portion 546. It will be noted that second rear wall portion 544 is parallel to third front wall portion 536.

FIG. 22B is a first side view of yet another alternative insert member 700 and corresponding partition P_Alt2. The shapes and interrelationships between insert member 700 and partition P_Alt2 differ from that of insert member 300 and its corresponding partition, and from insert member 500 and its corresponding partition. However, the combined body of insert member 700 and partition P_Alt2 provide the same combinations of front wall portions and rear wall portions that are provided by the combined body of insert member 300 and its corresponding partition as well as insert member 500 and its corresponding partition. They thereby provide structures for molding the same blocks, such as the blocks shown in FIGS. 20A-C.

In this embodiment, like insert member 300 but in contrast to insert member 500, insert member 700 includes a vertical fourth front wall portion 738. As such, the front side of the insert body of insert member 700 includes a front wall extending between first and second sides, and has, in seriatim from its bottom side to its top side, a vertical first front wall portion 732, then a convexly-arched vertical second front wall portion 734, and then a rearwardly-oblique (i.e. ramped up and to the right in FIG. 22B) third front wall portion 736. The rear side of the insert body of insert member 700 includes a rear wall extending between its first and second sides, and has, in seriatim from the bottom side to the top side, a vertical first rear wall portion 742, then a rearwardly-oblique (i.e. ramped up and to the right) second rear wall portion 744, and then a convexly-arched vertical third rear wall portion 746. It will be noted that second rear wall portion 744 is parallel to third front wall portion 736.

While embodiments have been described, alternatives are possible.

For example, a given insert member may include only one of the front side or rear side convexly-arched wall portions, thereby to mitigate malformation on only one of the top side and bottom sides of the retaining wall block being formed.

### CLAUSES

Clause 1. An insert member for a retaining wall block mold, the insert member comprising: an insert body comprising: a top side and a bottom side opposite the top side; a front side and a rear side opposite the front side; and a first side and a second side opposite the first side; the front side having a front wall extending between the first and second sides and having at least, in seriatim from the bottom side to the top side: a vertical first front wall portion; a convexly-arched vertical second front wall portion; and a rearwardly-oblique third front wall portion; the rear side having a rear wall extending between the first and second sides and having at least, in seriatim from the bottom side to the top side: a vertical first rear wall portion; a rearwardly-oblique second rear wall portion, the second rear wall portion parallel to the third front wall portion; and a convexly-arched vertical third rear wall portion.

Clause 2. The insert member of clause 1, wherein a vertical height of the first rear wall portion is greater than a combined vertical height of the first and second front wall portions.

Clause 3. The insert member of clause 1, wherein a vertical height of the first rear wall portion is the same as a combined vertical height of the first and second front wall portions.

Clause 4. The insert member of clause 1, wherein the third rear wall portion is convexly-arched to a maximum extent of from about 2 millimeters (mm) to about 5 mm.

Clause 5. The insert member of clause 1, wherein the third rear wall portion is convexly-arched to a maximum extent of about 2 millimeters (mm).

Clause 6. The insert member of clause 1, wherein the third rear wall portion is convexly-arched to a maximum extent of about 3 millimeters (mm).

Clause 7. The insert member of clause 1, wherein the third rear wall portion is convexly-arched to a maximum extent of about 4 millimeters (mm).

Clause 8. The insert member of clause 1, wherein the second rear wall portion is convexly-arched to a maximum extent of about 5 millimeters (mm).

Clause 9. The insert member of clause 1, further comprising, between the third front wall portion and the top side: a vertical fourth front wall portion.

Clause 10. The insert member of clause 1, wherein the front wall and the rear wall have the same vertical height.

Clause 11. The insert member of any one of clauses 1 to 10, wherein at least one of the vertical first front wall portion, the rearwardly-oblique third front wall portion, the vertical first rear wall portion, and the rearwardly-oblique second rear wall portion, is planar.

Clause 12. A retaining wall block formed using a mold that includes the insert member of any one of clauses 1 to 11.

Clause 13. A mold for manufacturing at least one interlocking dry-cast concrete retaining wall block, the at least one block having a top side having a transverse profile comprising at least one interlocking structure projecting from or recessed into the top side, and a bottom side having a transverse profile comprising at least one complementary interlocking structure recessed into or projecting from the bottom side, the mold comprising: a mold box, comprising front side and rear side walls joined to first side and second side walls to define a mold cavity, a top face, and a substantially open bottom face; partitions configured to define a space between adjacent blocks or a space between a block and a front side wall or a rear side wall of the mold box, extending substantially parallel to the front side wall and the rear side wall of the mold box substantially from the top face into the mold cavity, at least a longitudinal portion of at least some of the partitions being configured to form, without interlocking in a vertical direction with, a first transverse portion of the profile of the top side of one block or a first transverse portion of the profile of the bottom side of an adjacent block, or both, wherein the first transverse portions do not include any undercut portion that would impede vertically lifting the mold box including the partitions off of molded blocks; and at least one removable insert comprising insert members which, when positioned in the mold box in vertical correspondence with respective partitions, extend substantially parallel to the front side wall and the rear side wall and are configured to occupy the space between adjacent blocks, or the space between a block and a front side wall or a rear side wall of the mold box, for forming a remaining transverse portion of the profile of the top side of one block or a remaining transverse portion of the profile of the bottom side of an adjacent block, or both; wherein at least one of the partitions and a corresponding insert member for forming both the transverse portion of the profile of the top side of one block and the transverse portion of the profile of the bottom side of an adjacent block together form a combined body, the combined body having: a front wall extending between first and second sides of the combined body and having, in seriatim from the bottom side to the top side of the mold box: a vertical first front wall portion; a convexly-arched vertical second front wall portion; a rearwardly-oblique third front wall portion; and a vertical fourth front wall portion; and a rear wall opposite the front wall, the rear wall extending between the first and second sides of the combined body and having, in seriatim from the bottom side to the top side of the mold box: a vertical first rear wall portion; a rearwardly-oblique second rear wall portion, the second rear wall portion parallel to the third front wall portion; a convexly-arched vertical third rear wall portion; and a vertical fourth rear wall portion.

Clause 14. A retaining wall block formed using the mold of clause 13.

Clause 15. A retaining wall block comprising: a block body comprising: a top side and a bottom side opposite the top side; a front side and a rear side opposite the front side; and a first side and a second side opposite the first side; the bottom side having, in seriatim from the rear side to the front side: a horizontal first bottom side portion; an upwardly-oblique second bottom side portion; an at least partially concavely-arched horizontal third bottom side portion; and a horizontal fourth bottom side portion; and the top side having, in seriatim from the rear side to the front side: a horizontal first top side portion; an at least partially concavely-arched horizontal second top side portion; an upwardly-oblique third top side portion, the third top side portion parallel to the second bottom side portion; and a horizontal fourth top side portion.

Clause 16. The retaining wall block of clause 15, wherein the at least partially concavely-arched horizontal third bottom surface portion is fully concavely-arched.

Clause 17. The retaining wall block of clause 15, wherein the at least partially concavely-arched horizontal third bottom surface portion is a partially-collapsed concavely-arched horizontal third bottom surface portion.

Clause 18. The retaining wall block of clause 17, wherein the partially-collapsed concavely-arched horizontal third bottom surface portion has, along an extent between the first side and the second side of the block body, at least one substantially concavely-arched region and at least one substantially collapsed concavely-arched region.

Clause 19. The retaining wall block of clause 17, wherein the partially-collapsed concavely-arched horizontal third bottom surface portion has, along the entirely of an extent between the first side and the second side of the block body, a partially-collapsed concavely-arched horizontal region.

Clause 20. A set of retaining wall blocks comprising: a plurality of the retaining wall block of clause 15, wherein: in at least one of the plurality, the at least partially concavely-arched horizontal third bottom surface portion is fully concavely-arched; and in at least one of the plurality, the at least partially concavely-arched horizontal third bottom surface portion is an at least partially-collapsed concavely-arched horizontal third bottom surface portion.

What is claimed is:

1. An insert member for a retaining wall block mold, the insert member comprising:
an insert body comprising:
a top side and a bottom side opposite the top side;
a front side and a rear side opposite the front side; and
a first side and a second side opposite the first side;
the front side having a front wall extending between the first and second sides and having at least, in seriatim from the bottom side to the top side:
a vertical first front wall portion;
a convexly-arched vertical second front wall portion; and
a rearwardly-oblique third front wall portion;
the rear side having a rear wall extending between the first and second sides and having at least, in seriatim from the bottom side to the top side:
a vertical first rear wall portion;
a rearwardly-oblique second rear wall portion, the second rear wall portion parallel to the third front wall portion; and
a convexly-arched vertical third rear wall portion.

2. The insert member of claim 1, wherein a vertical height of the first rear wall portion is greater than a combined vertical height of the first and second front wall portions.

3. The insert member of claim 1, wherein a vertical height of the first rear wall portion is the same as a combined vertical height of the first and second front wall portions.

4. The insert member of claim 1, wherein the third rear wall portion is convexly-arched to a maximum extent of from about 2 millimeters (mm) to about 5 mm.

5. The insert member of claim 1, wherein the third rear wall portion is convexly-arched to a maximum extent of about 2 millimeters (mm).

6. The insert member of claim 1, wherein the third rear wall portion is convexly-arched to a maximum extent of about 3 millimeters (mm).

7. The insert member of claim 1, wherein the third rear wall portion is convexly-arched to a maximum extent of about 4 millimeters (mm).

8. The insert member of claim 1, wherein the second rear wall portion is convexly-arched to a maximum extent of about 5 millimeters (mm).

9. The insert member of claim 1, further comprising, between the third front wall portion and the top side:
a vertical fourth front wall portion.

10. The insert member of claim 1, wherein the front wall and the rear wall have the same vertical height.

11. The insert member of claim 1, wherein at least one of the vertical first front wall portion, the rearwardly-oblique third front wall portion, the vertical first rear wall portion, and the rearwardly-oblique second rear wall portion, is planar.

12. A retaining wall block formed using a mold that includes the insert member of claim 1.

13. A mold for manufacturing at least one interlocking dry-cast concrete retaining wall block, the at least one block having a top side having a transverse profile comprising at least one interlocking structure projecting from or recessed into the top side, and a bottom side having a transverse profile comprising at least one complementary interlocking structure recessed into or projecting from the bottom side, the mold comprising:
a mold box, comprising front side and rear side walls joined to first side and second side walls to define a mold cavity, a top face, and a substantially open bottom face;
partitions configured to define a space between adjacent blocks or a space between a block and a front side wall or a rear side wall of the mold box, extending substantially parallel to the front side wall and the rear side wall of the mold box substantially from the top face into the mold cavity, at least a longitudinal portion of at least some of the partitions being configured to form, without interlocking in a vertical direction with, a first transverse portion of the profile of the top side of one block or a first transverse portion of the profile of the bottom side of an adjacent block, or both, wherein the first transverse portions do not include any undercut portion that would impede vertically lifting the mold box including the partitions off of molded blocks; and
at least one removable insert comprising insert members which, when positioned in the mold box in vertical correspondence with respective partitions, extend substantially parallel to the front side wall and the rear side wall and are configured to occupy the space between adjacent blocks, or the space between a block and a front side wall or a rear side wall of the mold box, for forming a remaining transverse portion of the profile of the top side of one block or a remaining transverse portion of the profile of the bottom side of an adjacent block, or both;
wherein at least one of the partitions and a corresponding insert member for forming both the transverse portion of the profile of the top side of one block and the transverse portion of the profile of the bottom side of an adjacent block together form a combined body, the combined body having:
a front wall extending between first and second sides of the combined body and having, in seriatim from the bottom side to the top side of the mold box:
a vertical first front wall portion;
a convexly-arched vertical second front wall portion;
a rearwardly-oblique third front wall portion; and
a vertical fourth front wall portion; and
a rear wall opposite the front wall, the rear wall extending between the first and second sides of the combined body and having, in seriatim from the bottom side to the top side of the mold box:
a vertical first rear wall portion;
a rearwardly-oblique second rear wall portion, the second rear wall portion parallel to the third front wall portion;
a convexly-arched vertical third rear wall portion; and
a vertical fourth rear wall portion.

14. A retaining wall block formed using the mold of claim 13.

15. A retaining wall block comprising:
a block body comprising:
a top side and a bottom side opposite the top side;
a front side and a rear side opposite the front side; and
a first side and a second side opposite the first side;
the bottom side having, in seriatim from the rear side to the front side:
a horizontal first bottom side portion;
an upwardly-oblique second bottom side portion;
an at least partially concavely-arched horizontal third bottom side portion; and
a horizontal fourth bottom side portion; and
the top side having, in seriatim from the rear side to the front side:
a horizontal first top side portion;
an at least partially concavely-arched horizontal second top side portion;
an upwardly-oblique third top side portion, the third top side portion parallel to the second bottom side portion; and
a horizontal fourth top side portion.

16. The retaining wall block of claim 15, wherein the at least partially concavely-arched horizontal third bottom surface portion is fully concavely-arched.

17. The retaining wall block of claim 15, wherein the at least partially concavely-arched horizontal third bottom surface portion is a partially-collapsed concavely-arched horizontal third bottom surface portion.

18. The retaining wall block of claim 17, wherein the partially-collapsed concavely-arched horizontal third bottom surface portion has, along an extent between the first side and the second side of the block body, at least one substantially concavely-arched region and at least one substantially collapsed concavely-arched region.

19. The retaining wall block of claim 17, wherein the partially-collapsed concavely-arched horizontal third bottom surface portion has, along the entirely of an extent between the first side and the second side of the block body, a partially-collapsed concavely-arched horizontal region.

20. A set of retaining wall blocks comprising:
a plurality of the retaining wall block of claim 15, wherein:
in at least one of the plurality, the at least partially concavely-arched horizontal third bottom surface portion is fully concavely-arched; and
in at least one of the plurality, the at least partially concavely-arched horizontal third bottom surface portion is an at least partially-collapsed concavely-arched horizontal third bottom surface portion.
